(19) United States
(12) Patent Application Publication
(10) Pub. No.: US 2026/0010246 A1
(43) Pub. Date: Jan. 8, 2026

(54) Retractable In-Device Strap

(71) Applicant: Samsung Electronics Co., Ltd., Suwon-si (KR)

(72) Inventors: Shafae Ali, Mountain View, CA (US); Ivan France, Saratoga, CA (US); Curtis Aumiller, San Jose, CA (US)

(21) Appl. No.: 18/763,343

(22) Filed: Jul. 3, 2024

(51) Int. Cl. G06F 3/039; A63F 13/212

(52) U.S. Cl. CPC G06F 3/039; A63F 13/212

(57) ABSTRACT

In one embodiment, an apparatus includes a retractable strap that is attached at a first strap end to an internal portion of a human-interface-device (HID) controller that includes at least one of an extended reality (XR) controller or a mouse controller. The apparatus includes strap exit point is located on an exterior surface of the HID controller and an anchor on a portion of the HID controller, the anchor configured to removably secure a second strap end to the HID controller, so that the strap and HID controller form a closed loop when the second strap end is secured to the anchor, and the strap and HID controller do not form a closed loop when the second strap end is not secured to the anchor.

### TECHNICAL FIELD

This application generally relates to a retractable in-device strap.

### BACKGROUND

A human interface device (HID) is a computing device that can receive human input and provide output to a human. For example, input can be commands for the computing device to perform some functionality. Output can include graphical output, audio output, tactile output, etc.

Controllers are often used as an HID to interact with a computing device. For example, a computer keyboard is often used as an HID to provide alphanumeric input to a computing device, and a mouse is often used as an HID to interact with graphical content displayed on a display. Controllers may also be used as HID devices to interact with an extended reality (XR) system. An XR system can include displaying computer-generated content combined with a real-world scene, for example as in augmented reality (AR) or mixed reality (MR), or can include display of only computer-generated content, such as in virtual reality (VR). The display is often three dimensional. An XR system can include, for example, a head-mounted display (HMD), such as a headset, a pair of glasses, etc., that includes one or more displays for displaying XR content. XR content can include virtual objects or content from one or more applications, such as a web browser, a productivity application, a gaming application, etc., and this content can be displayed along with portions of a user's physical environment, i.e., the real-world environment in the vicinity of the user.

Other typically hand-held HIDs include phones and cameras.

### BRIEF DESCRIPTION OF THE DRAWINGS

FIG. 1 illustrates a view of an example HID controller.

FIG. 2 illustrates an example of strap that is permanently affixed to an HID controller and can be retracted or extracted from the HID controller.

FIG. 3 illustrates an example interior of an example HID controller.

FIG. 4 illustrates a set of example tabs and anchors.

FIG. 5 illustrates an example computing system.

### DESCRIPTION OF EXAMPLE EMBODIMENTS

A strap is a flexible strip of material that is used to secure a HID to a user, typically to the user's wrist and/or hand. Straps protect an HID from accidental drops and keep the HID with the user. Straps are particularly important for HID controllers, as they prevent the controller from being thrown and damaging items or contacting people in the area. For example, a user of an XR controller may be moving the controller while using the controller, and a strap secures the controller in case the controller is accidentally released due to acceleration the controller experiences during such movements. Well-designed straps help secure an HID without interfering with the user's grip, e.g., by allowing the users fingers to freely interact with the HID, and/or by allowing the user to release the controller without dropping it, freeing the user's hand to interact with other objects.

A variety of straps exist. For HID controllers, a strap typically loops around the user's wrist area or around the user's hand, e.g., the palm. Wrist-type straps are typically, but not necessarily, looser than a hand or palm-type strap, which tend to fit more tightly than do wrist-type straps. There are a variety of strap types. One common implementation of a strap is a strip of flexible material (e.g., synthetic or natural material) that forms a loop. The size of a loop worn by a user may be adjusted by a loop adjuster that can slide across the strap. The strap may attach at one end to a loop of thin thread-like material (e.g., nylon material), and this thread-like material may attach the strap to the controller by inserting the thread-like material through a pair of holes in the HID, or by inserting the thread-like material into a block in the HID. As a result, the strap is attached to the HID device and hangs freely from the HID device. The user can insert their hand or wrist through the strap and may be able to adjust the size of the strap using the loop adjuster.

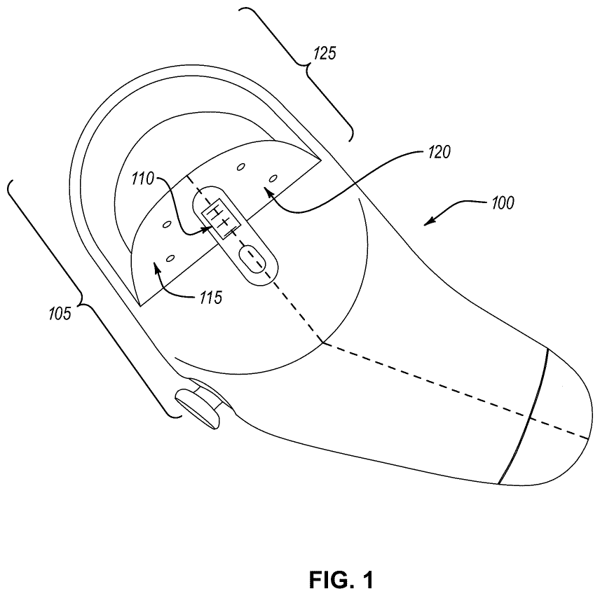

The straps described above may be attached or detached from a controller, but such straps are either physically present near the device (i.e., when attached) or rendered non-functional (when detached). However, for many HIDs, it is useful to have a strap present at some times and have no strap present at other times. For example, FIG. 1 illustrates a view of an example HID controller 100 that includes an XR controller portion and a mouse portion. Specifically, HID controller 100 includes a portion 105 that includes mouse portions and XR controller portions. For example, the mouse portion of HID 100 includes a scroll wheel 110 and left buttons and right buttons 115 and 120, respectively. An HID controller may also include an optical sensor. HID controller 100 also includes a portion 125 that operates as a controller in XR space, for example using infrared tracking techniques. In particular embodiments, some or all of the mouse portion of HID 100 (e.g., scroll wheel 110, an optical sensor for pointing controls, etc.) can also be used to control an XR environment, for example by using the mouse to control a cursor on a virtual screen, using the mouse to move a ray interactor, etc. HID controller 100 enables a user to transition from traditional computing activities (e.g., by using the mouse portion to control a computer) and XR computing activities by using the same controller in either instance. Additional descriptions of example HID controllers may be found in U.S. patent application Ser. No. 18/226,685, which is incorporated herein by reference.

With reference to example HID controller 100, when a user operates HID controller 100 as an XR controller, then the user may wish to have a strap present to secure the controller to the user's body. In contrast, when the user operates HID controller 100 as a computer mouse, then the user may not want to wear the strap, as the user's hands may move from the mouse to other objects (e.g., the keyboard), and the user may not want to drag the mouse around as the user operates the computer. In the latter use cases, while a user may choose not to wear a strap, having a strap hanging from the HID device may interfere with the user's ability to use the mouse, for example by restricting the mouse's motion on a surface and/or by being uncomfortable for the user to rest their hand on or against. The user may entirely remove the strap from the controller, for example as described above, but this often requires physically dissembling some portion of the device's structure, and risks misplacing or losing the strap. Moreover, if a user repeatedly switches from controller-type usage to mouse-type usage, then having to detach and reattach the strap is not practical and would substantially interfere with the user's ability to seamlessly switch between uses of the controller.

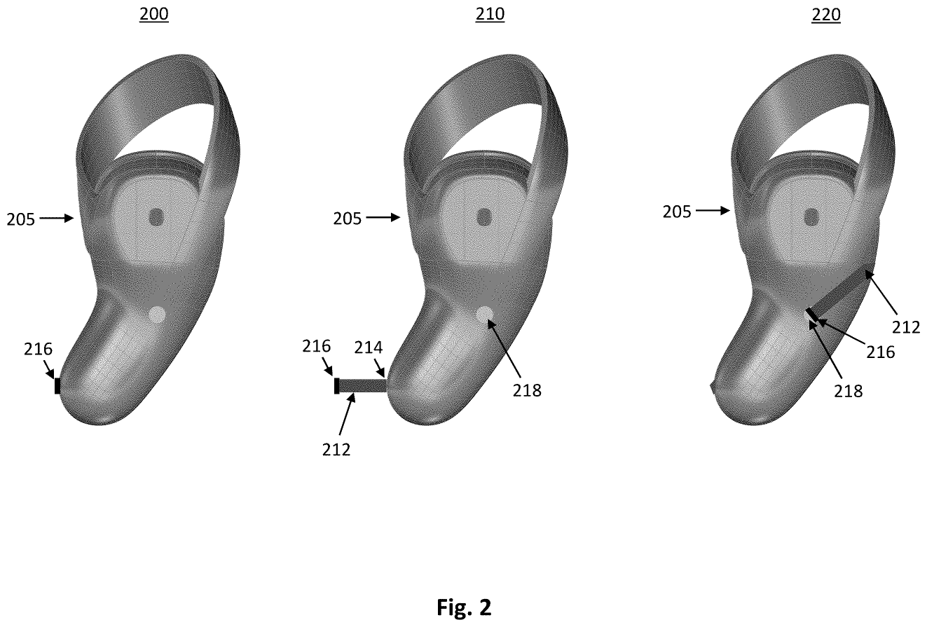

In contrast, FIG. 2 illustrates an example of strap that is permanently affixed to the HID but can be retracted or extracted from the HID body as needed, thereby allowing the user to conveniently and selectively engage the strap as desired. Image 210 of FIG. 2 illustrates an example in which a portion of strap 212 is withdrawn from an exit point 214 of HID device 205. One end of strap 212 may contain a terminal component, such as tab 216, while the other end is permanently affixed to an internal portion of HID 205. HID 205 may include an anchor point 218, which can selectively engage tab 216 to secure both ends of the strap to the device, thereby forming a closed loop out of strap 212 and HID device 205. Image 220 illustrates an example in which strap 212 is attached to anchor 218 via tab 216. Image 200 illustrates an example in which strap 212 is retracted fully (or almost fully) into HID 205, leaving only a portion of tab 216 protruding from HID 205. In particular embodiments, no portion of tab 216 may extend past the exterior of HID 205. In particular embodiments, a portion of HID 205 near strap exit point 214 may be at least partially compressible, so that a user can push that portion towards the interior of HID device 205, thereby causing some (or more) of tab 216 to extend past the exterior of HID 205, making it easer to grasp tab 216 and extend it from HID 205. In particular embodiments, an HID may contain a release mechanism (e.g., a button) to draw the tab to the outside of the HID device.

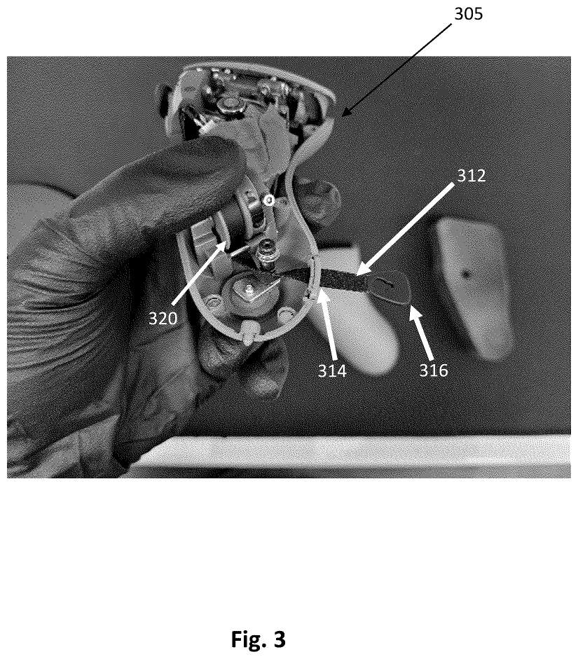

FIG. 3 illustrates an example interior of HID 305. In FIG. 3, strap 312 (including tab 316) extends partially past the exterior of HID 305 through exit point 314, while the majority of strap 312 remains within the interior of HID 305. In the example of FIG. 3, a self-retracting spool 320 within the body of HID device 305 is used to tension strap 312, thereby retracting strap 312 into the device body when the strap is not engaged with an anchor. In addition, a self-retracting spool may secure the strap against a user, ensuring a snug and secure fit against the user's body.

In particular embodiments, a pre-tensioned spiral torsional spring within a self-retracting spool can be used to store elastic potential energy, and can be used to rotate a spool that the strap winds around. The spring constant can be such that the force of the spiral torsion spring pulling the strap back into the interior of the HID is greater than the estimated maximum force caused by the acceleration the controller would experience when thrown out of the hand of a user. This also allows the tightness of the strap around the user hand/wrist to feel near constant in normal use.

In particular embodiments, a strap may be pre-tensioned so that the strap is always under tension and therefore always retracts back inside the controller body The self-retraction always pulls the tab (the second end of the strap) into the controller to also prevent any unnecessary slack that would cause the strap to hang loose. To achieve pre-tensioning, a torsional spring may be rotated slightly before it is fixed inside the controller body. This can be achieved by having a rotating element in the center of the torsion spring that can lock in place, or rotation of the entire spool body while keeping the center hold pin fixed; in both variations the other end of the spring must also remain fixed. For instance, to pre-tension a strap in a spiral torsion spring configuration, particular embodiments may first involve passing the strap through the controller body. One end of the strap is fixed to the spool, and the strap is fully wound around the spool. A torsional spring is mounted inside the spool on a pin (with the outer end of spring fixed on the spool, and the inner end fixed to the pin). The pin is rotated while keeping the spool fixed (i.e. outer edge of spring stays fixed) or the spool is rotated and the pin is kept fixed (i.e. inner edge of spring stays fixed). The strap is thus pretensioned.

In particular embodiments, a rachet mechanism may be used for different levels of pre-tensioning a strap, and/or for locking the tension at certain points along the length of the strap. For example, the strap can be ratcheted to provide fixed intervals where the strap stays extended. The range over which self retraction happens is then at discrete intervals set by the rachet mechanism, and the strap must either be fully extended to return the full strap length back into the controller, or a button may be pressed to release the ratchet. The strap can be guided using internal posts or slots to enable the area of exit to be in any orientation in relation to the controller to prevent jams due to unintentional twisting/folding of the strap. For example, particular embodiments may use an internal post, which may be a bushing or set of bearings, to change the direction of a strap without causing twists. For instance, the strap may press against the post and therefore cannot twist along the width of the strap's body. In addition or the alternative, particular embodiments may use internal slots to guide a strap and prevent it from intersecting with other internal components.

While certain examples above describe embodiments in which a spool is used to provide self-retraction for a strap, other self-retraction mechanisms may be used. For example, a strap may be wound around a spool, wrapped between posts, attached to a linear spring, folded in a stack, etc. Particular embodiments may use more than one spool in parallel, as doing so increases the stored elastic potential energy, meaning the stiffness of a strap's pull can be increased beyond single torsional spring limit. Multiple spools can also allow alternative strap storage volumes, such as a pill-shaped volume (with a spool at each “end” of the pill shape).

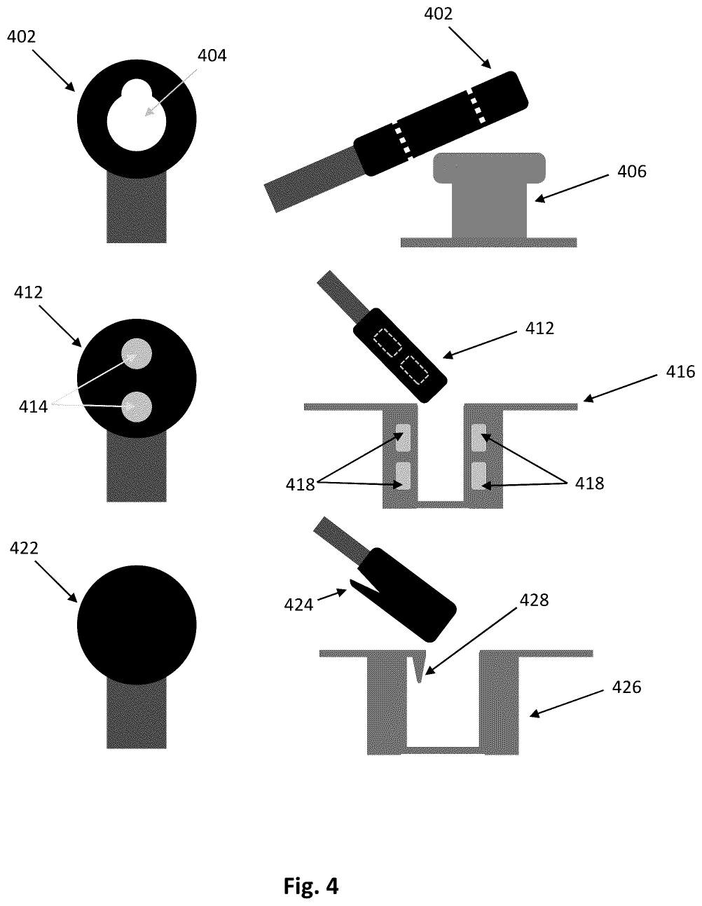

A tab can take any suitable shape. For instance, a tab may be a relatively circular shape, but other shapes (e.g., square, triangular, etc.) may be used. The tab can be designed to use any suitable attachment method to mechanically connect to the tab anchor point. For instance, attachment methods may include magnets, latches, pins, hooks, etc., or a combination of one or more attachment mechanisms. For example, FIG. 4 illustrates a set of example tabs and anchors. Tab 402 may contain a hole 404. Tab 402 may be placed onto pin-type anchor 406 so that the anchor extends through hole 404, thereby affixing the strap to the anchor. Tab 412 may include one or more magnets 414, which can be used to secure the strap to corresponding magnets 418 in anchor 416. Magnet orientations in the anchor can be set so that surfaces attract or repel intentionally to help self-locate the tab. As another example, tab 422 may include a hook negative 424, which may attach to a corresponding hook positive 428 in anchor 426 to secure the strap to the anchor.

While FIGS. 2 and 3 illustrate example locations of a strap exit point and an anchor, this disclosure contemplates that other locations on a device body may be used. For example, a strap exit point and a strap anchor may be co-located, in particular embodiments, so that those components are functionally by each other (but not blocking each other). In particular embodiments more than one anchor point may be used, and/or the location of an anchor point may be adjustable by a user.

In particular embodiments, one or more sensors such as a hall effect or rotary encoder can be used to detect if the wrist strap is locked in place, and/or to detect an approximate hand or wrist circumference of a user. For example, a Hall-effect sensor may be placed near a magnetic anchor, and this sensor may detect the presence or absence of the tab at the anchor. As another example, a spool may be attached to a rotary encoder to determine the length of the extended strap, which may be used to approximate a hand or wrist circumference.

In particular embodiments, a strap may be released from an anchor using a one-handed release mechanism. For example, a button positioned e.g., near a thumb portion of an HID] may selectively disengage an anchor. For instance, a pin-type tab anchor may be depressed using the button, or by pressing down on the pin. A button may engage an electromagnet to release or lock a magnetic tab, or a positive hook may have a rotating hinge to selectively release the tab. While the examples above describe a button as engaging a release mechanism, this disclosure contemplates that any other user-interface element may be used.

To engage a strap with one hand, an input on the controller body can be used. The strap can be designed to have an active mechanism. The strap can be made from a flexible bistable material, such as a stainless steel spring band so that it can retract back into the controller body in a coil, or be extended out as a rigid body and be collapsed to wrap around the hand. The steel band can be protected in a soft sheathing, such as fabric or silicone, to prevent corrosion and not cut the user. A spring band is a re-usable, self tensioning mechanism built up of layered stainless steel spring bands in order to be stable in 2 geometrical states (i.e. coiled or straight). Such embodiments combine the strap and the spring mechanism into one. A torsional spiral spring which is motorized to extend the strap could alternatively be used; however in this embodiment the strap would be flaccid once released from the controller body, and still requires a second hand to attach on to the tab anchor, problems that are addressed by the bistable material embodiments discussed above.

A strap may be made of any suitable material such as leather, nylon, cotton, composite fabric, etc. The strap may have any suitable cross section, such as rectangular, square, circular, triangular, or knitted (e.g., “FIG. 8” patterned). A strap can include a capacitive material to detect the presence of a hand as a safety feature to prevent misuse of the strap.

In particular embodiments, a strap exit point can include a layer of low friction material, e.g., plastic, to reduce wear and reduce the force needed to extract/retract. In particular embodiments, small brushes may be located at the exit point of a strap to clean the strap when the strap is retracted or extracted (e.g., the brushes may be located beside, and rub against, opposite sides of a strip's cross-sectional width).

While several examples of retracting straps described above relate to straps for an HID that includes a controller, other device types may be used for any suitable primarily hand-held device, such as a phone, a camera, etc.

While strap styles are typically limited to being worn around the wrist, unless after market straps are bought, a retractable strap that can be withdrawn from the controller makes it possible to wrap in a variety of different ways before locking the strap to the anchor; the strap can provide multiple configurations to go around a user's wrist or hand. Moreover, the portion of the strap outside of the device can be varied in length as desired by a user. In contrast, while conventional straps may have a loop adjuster, a loop adjuster does not adjust the overall amount of a strap that is outside a device.

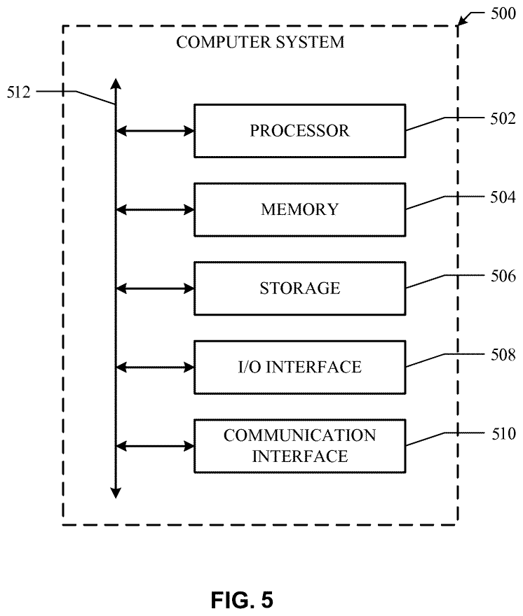

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate.

Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. An apparatus comprising:
a retractable strap that is attached at a first strap end to an internal portion of a human-interface-device (HID) controller comprising at least one of (1) an extended reality (XR) controller or (2) a mouse controller;
a strap exit point located on an exterior surface of the HID controller; and
an anchor on a portion of the HID controller, the anchor configured to removably secure a second strap end to the HID controller, wherein the strap and HID controller form a closed loop when the second strap end is secured to the anchor, and wherein the strap and HID controller do not form a closed loop when the second strap end is not secured to the anchor.

2. The apparatus of claim 1, wherein the HID controller comprises an XR controller portion and a mouse controller portion.

3. The apparatus of claim 1, further comprising one or more pre-tensioned spools disposed in an interior of the HID controller and configured to retract the strap into the interior of the HID controller.

4. The apparatus of claim 3, wherein the one or more pre-tensioned spools comprise a rachet mechanism.

5. The apparatus of claim 1, wherein the second strap end comprises a tab.

6. The apparatus of claim 5, wherein:
the tab comprises a hole surrounded by an outer tab material; and
the anchor comprises a pin.

7. The apparatus of claim 5, wherein:
the tab comprises one or more tab magnets; and
the anchor comprises one or more anchor magnets.

8. The apparatus of claim 5, wherein:
the tab comprises a negative hook; and
the anchor comprises a positive hook configured to intercouple with the negative hook of the tab.

9. The apparatus of claim 1, wherein the anchor is co-located with the strap exit point.

10. The apparatus of claim 1, further comprising one or more sensors configured to detect whether the second end of the strap is engaged with the anchor.

11. The apparatus of claim 1, further comprising one or more sensors configured to determine a length of a strap portion that extends outside of the HID controller.

12. The apparatus of claim 1, further comprising one or more brushes disposed at the strap exit point and configured to clean the strap while the strap is drawn into or out of the HID controller.

13. The apparatus of claim 1, further comprising a user interface on a body of the HID controller configured to engage a release mechanism configured to release the second end of the strap from the anchor.

14. The apparatus of claim 1, further comprising a layer of low-friction material at the strap exit point.

15. The apparatus of claim 1, wherein when the strap is fully retracted into an interior of the HID controller, the second strap end extends past the exterior surface of the HID controller.

16. A method comprising:
extracting a retractable strap from an interior of a human-interface-device (HID) controller comprising at least one of an extended reality (XR) controller or a mouse controller, the retractable strap being attached at a first strap end to an internal portion of the HID controller and exiting the interior of the HID controller through a strap exit point;
looping the retractable strap around a hand or wrist area of a user; and
affixing a second end of the retractable strap to an anchor on a portion of the HID controller configured to removably secure the second strap end to the HID controller.

17. The method of claim 16, wherein the HID controller comprises an XR controller portion and a mouse controller portion.

18. The method of claim 16, further comprising:
detaching the second end of the retractable strap from the anchor; and
feeding the retractable strap into the interior of the HID controller through the strap exit point.

19. The method of claim 16, wherein the second strap end comprises a tab.

20. The method of claim 16, wherein the anchor is co-located with the strap exit point.
